(19) United States
(12) Patent Application Publication
(10) Pub. No.: US 2010/0117026 A1
(43) Pub. Date: May 13, 2010

(54) PRODUCT FOR ROUGHENING THE STRINGS OF TENNIS, BADMINTON AND SQUASH RACKETS AND FOR KEEPING THEM ROUGH AND METHOD FOR PRODUCING SAID PRODUCT

(76) Inventor: Bünyamin Sürmeci, Erlenbach (CH)

Correspondence Address: YI LI, CUSPA TECHNOLOGY LAW ASSOCIATES, 11820 SW 107 AVENUE, MIAMI, FL, 33176, US

(21) Appl. No.: 12/594,854

(22) PCT Filed: Apr. 8, 2008
(86) PCT No.: PCT/CH2008/000159

§ 371 Date: Oct. 6, 2009

(30) Foreign Application Priority Data
Apr. 10, 2007 (CH) 588/07

(51) Int. Cl. C09K 3/00

(52) U.S. Cl. 252/182.29

(57) ABSTRACT

The agent basically consists of Saxolith, a crystalline marble-based filler, and Erkamar, a binder having adhesive properties. The agent preferably also contains dimethylethanolamine to improve the dissolution of resins and to stabilize the pH, as well as isopropanol as the diluent, Sipernat to improve the flow properties, Agitan as defoaming agent and coagulant, as well as Byk to improve the flow properties and as a filler. The agent is produced by adding Erkamar to at least the same quantity of water, mixing it and stirring it for a few hours, cooling the mixture to room temperature, and adding at least the same quantity of Saxolith as that of Erkamar added previously and stirring until a homogeneous mixture is obtained.

The present invention relates to an agent for treating the racket strings of tennis rackets, badminton and squash rackets so that the strings have a rough surface. This rough surface is particularly important for the execution of strokes, which are designed to give the ball a twist or spin. Furthermore, the invention relates to a method for the production of this agent.

In recent years, the tennis sport has undergone a rapid development under which the game dynamics as well as the speed of the game has increased tremendously. The same applies to related varieties such as badminton and squash. The tennis rackets are exposed to a large load. Professional players use a racket only for a single game. The newly put on strings of a tennis-racket-string are in fact grainy and rough. They allow to play, while cutting the ball in striking, to produce a twist on it. Only with a rough surface of the strings, a force component can be transferred to the ball, which affects approximately transversely to the trajectory, and runs along the string surface. But the roughness of a racket-string leaves soon due to the wear of the strings. The more often it is being played with spin, which is more often the case with advanced players, the faster the strings become smooth and dull for a challenging game. While professional players therefore rely on rackets with new strings for every match, this is too burdensome and expensive for amateurs and hobby players. Nevertheless, of course, is also the desire of the amateur players to use an optimal racket. It is established that one can play one category better with a new tennis racket than with one having tired and dull strings. The same applies to the rackets for playing badminton and squash.

It is therefore the object of this invention to provide an agent to make and maintain the racket strings for tennis, badminton and squash rough, whereby the agent sould be easy and safe to apply and should keep the strings of a racket rough for an extended period of time, so that a player can produce a stronger stroke and higher spins. The strings should be protected by this agent and therefore become more durable. Moreover, it is an object of the invention to provide a process for the production of this agent.

This problem is solved by an agent for making the racket strings for tennis, badminton and squash rough and keeping it rough, consisting of at least the two components Saxolith, a crystalline filler on marble base, and ERKAMAR, a binder with adhesive properties.

The method for manufacturing the agent is characterized in that ERKAMAR is mixed in water of at least equal volume and the mixture is stirred for several hours, the mixture is cooled to room temperature, afterwards Saxolith is added at least in the same volume as that of ERKAMAR added, and then the mixture is stirred until a homogeneous mixture is achieved.

The following discloses the production method and the produced agent by means of examples of execution. As essential components, the agent contains a granular mass whose grains are sharp-edged and have a great hardness which ensures that those sharp body edges remain sharp under wear as long as possible. Furthermore, the agent contains a binder with adhesive properties which ensures that the grains are embedded in it, and that a tight and strong bond to the surface of the strings is established, which persists even under wear and is durable.

This has been shown that Saxolith proves to be an advantageous means for obtaining and ensuring the roughness. Saxolith is basically a crystalline calcium carbonate filler material which contains marble. It is available in various types and grain sizes, according to the following table:

| | Saxolith 2 HE | Saxolith 5 HE | Saxolith 8 HE | Saxolith 10 HE |
|---|---|---|---|---|
| Grain | 0-11 mm | 0-27 mm | 0-38 mm | 0-60 mm |
| size | | | | |
| | Saxolith 2 LE | Saxolith 5 LE | Saxolith 8 LE | Saxolith 10 LE |
| Grain | 0-11 mm | 0-27 mm | 0-38 mm | 0-60 mm |
| size | | | | |

In principle, each of these ideal types is suitable to achieve the desired roughness. By mixing of different types, a targeted mixture can be obtained, and by no surprise, the rougher the surfaces become, the less durable is their roughness.

To apply the Saxoliths onto the strings of a racket, Saxolith must be placed into a binder agent, for example in the form of a viscous liquid or a pasty mass, which afterwards can be applied to the strings, and which ensures a strong adhesion with the surface of the strings. Erkamar proves to be an advantageous binder with adhesive properties. This is a binder in the form of a resin, specifically a higher melting dispersing resin with a pigment load, which is soluble in alcohol and after neutralization is also soluble in water.

In order to produce the agent for making and keeping the strings rough, the procedure is as follows: First, ERKAMAR is mixed with at least the same quantity of water and stirred for several hours. Approximately 2 parts of ERKAMAR are being taken and mixed with about 3 parts of water. Then the mixture is stirred for several hours, at least for four hours. The mixture heats up meanwhile. Once a homogeneous mixture is obtained, it is allowed to cool down to room temperature. Only then Saxolith is mixed in, again in at least 2 parts, but preferably in about 2.5 parts. Then the mixture is stirred again until a homogeneous mixture of Saxolith with the liquid bonding agent is obtained. Thereafter, the agent is present in the form of a liquid, whitish to ocher antislip-lacquer and is ready to be applied onto the strings of a racket. The application can be easily done with a brush until all the string surfaces are covered and enclosed by the agent. Thereafter, this lacquer is completely dried out. In dealing with this water-based paint or lacquer respectively, one should consider the usual measures for handling chemicals. As a precautionary measures, protective gloves, safety goggles or a face shield should be worn. A respirator is not necessary though. This antislip-lacquer should not be stored below 0° C.

A particularly effective mixture and its preparation is given below. It contains:
Saxolith HE, consisting of crystalline calcium carbonate filler materials (marble),
Saxolith LE, consisting of fine crystalline calcium magnesium carbonate filler materials (dolomite marble),
dimethylethanolamine, is used to improve dissolution of the resin and to stabilize the pH-value,
Isopropanol, serves as a diluent, also for altering the viscosity,
ERKAMAR, serves as a binder with adhesive properties and ensures the adhesion on the strings of a racket.
Sipernat, serves to improve the flow properties, so that the agent is easy to apply and an nice, even covering of the strings is achieved.
Agitan is a defoamer and densification means and makes it possible to change the consistency in the desired manner,
Byk improves the flow behavior, while acting as a filler.

If a lot of 100 kg antislip-lacquer should be produced with these components, then the following procedure is applied: First, a mixture of the following components will be made:
30.4 kg of water
8.1 kg of dimethylethanolamine
6 kg of isopropanol
22.5 kg of ERKAMAR 3280

This 69.5 kg mixture is now mechanically stirred for 5 to 6 hours, until a nice homogeneous mixture is achieved. While stirring, the mixture heats up, and it is then set to rest for about 24 hours so that the mixture cools back to room temperature.

Hereafter, this usually means the next day, 27 kg of Saxolith 5 HE and 5 kg of Sipernat 820AG are added, as well as approximately 0.6 kg of Agitan E 120 and approximately 0.6 kg of Byk 420. This entire mixture is then stirred for about 4 to 5 hours, resulting in a thorough mixing, so that a liquid, whitish to ocher-colored, well brushable antislip-lacquer is obtained.

The grain size and the composition of the Saxolith portion can be varied at will in the scope of its overall portion in the mixture. This antislip-lacquer can then be brushed with a brush onto the strings of a racket, until the strings are covered on all sides and thus fully enclosed. Then the paint is left for drying and hardening properly, which is best done overnight. The next day the tennis racket or badminton or squash racket is ready to play. By this coating the surfaces of the strings are rough, and they remain rough for many hours of play time. When this coating of the strings is finally worn out, the strings can easily be brushed all over again. One then only brushes those parts of the strings which are worn out, predominantly the area around the center of the racket, and this can be repeated many times if necessary until the strings have lost their elasticity anyway and the strings or even the entire racket must be replaced.

Rackets treated with this antislip-lacquer immediately increase the striking power and spin of a particular male or female player, whether he/she is an ATP-/WTA-player or a club or hobby player. A positive side effect worth to mention: the durability of the strings is extended significantly. The strings are in fact protected by the coating of moisture and preserved while playing. The tensioning force of used strings or old strings can be increased by this coating and their effectiveness in playing is essentally better.

1. Agent for making and keeping strings of rackets for tennis, badminton and squash rough, consisting of at least two components: Saxolith, a crystalline filler on marble base, and Erkamar, a binder with adhesive properties.

2. Agent for making and keeping strings of rackets for tennis, badminton and squash rough according to claim 1, characterized in that said agent contains Saxolith of type HE, that is crystalline calcium carbonate filler material (marble).

3. Agent for making and keeping strings of rackets for tennis, badminton and squash rough according to claim 1, characterized in that said agent contains Saxolith of type LE, that is fine-crystalline calcium magnesium carbonate fillers (dolomite marble).

4. Agent for making and keeping strings of rackets for tennis, badminton and squash rough according to claim 1, characterized in that said agent contains Saxolith in a combination of two types of HE and LE.

5. Agent for making and keeping strings of rackets for tennis, badminton and squash rough according to claim 1, characterized in that said agent contains dimethylethanolamine for improving dissolution of resin and stabilizing pH.

6. Agent for making and keeping strings of rackets for tennis, badminton and squash rough according to claim 1, characterized in that said agent contains isopropanol as a diluent for altering viscosity.

7. Agent for making and keeping the strings of rackets for tennis, badminton and squash rough according to claim 1, characterized in that said agent contains Sipernat in order to improve flow properties.

8. Agent for making and keeping strings of rackets for tennis, badminton and squash rough according to claim 1, characterized in that said agent contains Agitan as a defoamer and densification agent, and Byk for improving flow behavior and as a filler.

9. Process for preparing an agent for making and keeping strings of rackets for tennis, badminton and squash rough, characterized in that Erkamar is mixed with at least a same quantity of water and is stirred for several hours, afterwards formed mixture is cooled down to room temperature, then Saxolith in at least the same amount as that of Erkamar is added and stirred until a homogeneous mixture is obtained.

10. Process for preparing an agent for making and keeping strings of rackets for tennis, badminton and squash rough, characterized in that 22.5 kg of Erkamar is mixed into 33 kg of water and stirred for 5 to 6 hours, afterwards formed mixture is cooled down to room temperature, and then 27 kg of Saxolith HE with 5 kg of Sipernat 820A and 0.6 kg of Agitan E120 and 0.6 kg of Byk 420 are added, and the mixture is stirred again for 4 to 5 hours.
